(19) United States
(12) Patent Application Publication
(10) Pub. No.: US 2026/0063911 A1
(43) Pub. Date: Mar. 5, 2026

(54) DISPLAY DEVICE

(71) Applicant: Apple Inc., Cupertino, CA (US)

(72) Inventors: Paul X. Wang, Cupertino, CA (US); Ray L. Chang, Saratoga, CA (US)

(21) Appl. No.: 19/076,200

(22) Filed: Mar. 11, 2025

Related U.S. Application Data
(60) Provisional application No. 63/688,027, filed on Aug. 28, 2024.

(51) Int. Cl. G02B 27/01; G02C 11/00

(52) U.S. Cl. CPC G02B 27/0176; G02C 11/10; G02B 2027/0152; G02B 2027/0156; G02B 2027/0158; G02B 2027/0178

(57) ABSTRACT

A display accessory for a wearable device can include a housing, and a transparent window secured to the housing. The display accessory for a wearable device can further include a waveguide disposed in the housing and configured to direct visible light at the transparent window to create an image, and a connector that can removably couple the housing to eyeglasses.

### CROSS-REFERENCE TO RELATED APPLICATION

This application claims the benefit of U.S. Provisional Patent Application No. 63/688,027, filed 28 Aug. 2024, and entitled “DISPLAY DEVICE,” the entire disclosure of which is hereby incorporated by reference.

### FIELD

The present disclosure relates generally to electronic devices. More particularly, the present disclosure relates to head-mountable electronic display devices and accessories.

### BACKGROUND

Various electronic devices offer an all-in-one head-mountable augmented reality (AR) experience. These electronic devices require the user to don the head-mounted electronic device on their head and mount the device over the user's eyes. These devices generally include a head strap that secures the device to the user's head to counter the weight of the device on the user's nose and face. These electronic devices are heavy and can be uncomfortable for the user to wear for an extended period of time. If the user wears eyeglasses, the devices may not be designed to don over the user's eyeglasses. In these cases, the user may buy prescription inserts for the device for proper use. Accordingly, there is a need for an electronic device that offers an AR experience that is lightweight, cost effective, and accommodating to users with eyeglasses and corrective lenses.

### SUMMARY

A display accessory for a wearable device can include a housing and a transparent window secured to the housing. The display accessory can further include a waveguide disposed in the housing and configured to direct visible light at the transparent window to create an image, and a connector that can removably couple the housing to eyeglasses such that the housing engages an upper frame of the eyeglasses.

The connector can include a proximal end secured to the housing and a distal end extending from the housing. The distal end of the connector can include a clip to removably couple the housing to the eyeglasses. The distal end of the connector can include a strap to removably couple to the housing of the eyeglasses. The connector can further include an electric port electrically coupled to the waveguide. The display accessory can have a housing that is a first housing, the transparent window can be a first transparent window, the waveguide can be a first waveguide, and the connector can be a first connector. The display accessory can further include a second housing, a second transparent window secured to the second housing, a second waveguide disposed in the second housing, and a second connector connected to the second housing. The first waveguide and the second waveguide can be communicatively connected. The display accessory can further include an antenna, wherein the first waveguide and the second waveguide are communicatively connected via the antenna. The connector can be a first connector that extends from the housing and the housing can include a second connector that can removably couple the housing to the eyeglasses. The display accessory can further include a nose pad that can removably couple to the eyeglasses and an ear pad that can removably couple to the eyeglasses.

A wearable display device can include a housing, a display assembly coupled to the housing, a transparent window secured to the housing, and a waveguide disposed in the housing to direct visible light at the transparent window to create an image. The wearable display device can further include a connector that can removably couple the housing to eyeglasses, and a power port disposed in the connector and electrically coupled to the waveguide. The power port can be electrically connected to an antenna. The power port can be electrically connected to a controller. The power port can be electrically connected to a speaker. The connector can include a securement arm extending from the housing. The connector can further include a proximal end secured to the housing and a distal end extending from the housing. The power port can be disposed on the distal end of the connector.

A wireless wearable display device can include a transparent window and a waveguide coupled to the window and configured to direct visible light at the transparent window to create an image. The wireless wearable display device can further include a securement arm cantilevered from the transparent window, including a power source electrically coupled to the waveguide.

The wireless wearable display device can further include a speaker housed in the securement arm and a multi-layer board (MLB) electrically coupled to the power source, the speaker, and the waveguide. The power source can include a battery. The power source can include an external power port.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a display accessory for a wearable device donned on a user;

FIG. 2A illustrates one example of a display device;

FIG. 2B illustrates one example of a display device connected to a pair of eyeglasses;

FIG. 3 illustrates a front view one example of a display device connected to a pair of eyeglasses;

FIG. 4 illustrates an isometric view of one example of a wearable display device;

FIG. 5A illustrates an isometric view of one example of a wireless wearable display device;

FIG. 5B illustrates a left side view of one example of a wireless wearable display device donned on a user's head.

FIG. 6A illustrates an ear pad attached to a pair of eyeglasses;

FIG. 6B illustrates a nose pad attached to a pair of eyeglasses;

FIG. 7A illustrates one example of a transparent window; and

FIG. 7B illustrates one example of a transparent window.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to electronic display devices and head mountable accessories. Current wearable devices can be heavy and fatigue the user during extended operation. These wearable devices also require the user to don the device over the user's head and eyes. If the user wears eyeglasses, such as sunglasses or corrective eyeglasses, the current wearable devices do not allow the user to use their eyeglasses with the device. For example, the user may need to purchase specific corrective eyeglass inserts to fit within the device to operate the wearable device. The display devices described herein are designed for comfort and extended use, the ability to use a wearable device with eyeglasses, and lowering the cost of an augmented reality (AR) experience. The display devices disclosed herein can include a display accessory for a wearable device, which can be removably coupled to the user's eyeglasses, thus enabling the user to wear their corrective eyeglasses and use the display device simultaneously.

In at least one example, a display device can include a housing and a connector extending from the housing. The connector can be configured to removably couple the housing of the display device to a user's eyeglasses. Examples of display devices can include optical devices (e.g., glasses, transparent windows, etc.) or virtual/augmented reality devices that can include an optical component. In these examples, the display device can be worn on the user's head while secured to the user's eyeglasses such that optically transparent windows, for example lenses and transparent optical displays, can be positioned in front of the user's eyes without significant effect on the user's normal vision. Other electrical components for the powering and operation of the device can be disposed in the device, for example, batteries and waveguides. An electronic port can be disposed distally on the connector and can be electrically coupled to various other electronic components of the device to provide a connection point for data or power cables.

As noted above, in some examples, the display device can be a display accessory for a wearable device and can be removably coupled to the user's eyeglasses. This can enable the user to wear their eyeglasses and use the display device simultaneously. To this end, the connector of the device can include a proximal end secured to a housing of the device and a distal end that can be used to removably couple to the eyeglasses. The display device can further include a waveguide. The waveguide can be configured to direct visible light at the transparent window to create an image. In this example, the connector can include an electrical port configured to power the display device. The electrical port can be electrically coupled to the waveguide. In this way a battery can be electrically coupled to the electric port via a wire. Such a display device can be lighter compared to current wearable devices and can allow the user to use wear their eyeglasses.

In some examples, the display devices described herein can include two frames and windows, as well as other components, to provide augmented-reality outputs to both eyes of the user. For example, a housing can be a first housing, a connector can be a first connector, and the display device can further include a second housing and a second connector. Such a device can a second waveguide associated with the second hosing and window. The device can also include an antenna such that the first waveguide and the second waveguide are in electrical communication via the antenna. In this example, the user can removably couple a first housing to the eyeglasses and removably couple a second housing to the same eyeglasses. The first housing and the second housing can be removably coupled to the user's eyeglasses by the first connector and the second connector, respectively. In one example, the user can attach only the first housing to the eyeglasses and utilize the device. In this way, the user may use the device in an information displaying mode. In another example, the user can attach the first housing and the second housing to the eyeglasses and utilize the device, providing a more stereoscopic experience. The device having a first housing and second housing can allow the user can decide to operate the device with only a first housing, only a second housing, or both depending on the intended application.

In another example, the wearable display device can include a housing and a connector that is configured to removably couple the housing to the user's eyeglasses. The connector can include a proximal end secured to the housing and a distal end. In this example, the device can include a display assembly. The display assembly can include a transparent window secured to the housing and a waveguide disposed in the housing. In this example, the wearable display device includes a power port that is electrically coupled to the waveguide. The power port can be disposed in the distal end of the connector. The device can further include an antenna, a controller, and a speaker. The antenna, the controller, and the speaker can be electrically connected to the power port. In one example, the connector can be a securement arm extending from the housing. In such an example, the controller and the speaker can be housed within the securement arm. In one example, the antenna can be housed within the securement arm. In another example, the antenna can be housed within the housing of the device. The power port can deliver stable power to all electrical components and manage power loss.

In yet another example, the wearable display device can be a wireless display device. In this example, the device can include a transparent window and a waveguide coupled to the transparent window. The device can further include a securement arm cantilevered from the transparent window. The securement arm can include a power source electrically coupled to the waveguide. In one example, the power source can be a battery. In another example, the power source of the device can include a port connectable to an external power source. The device can further include a speaker housed in the securement arm. The device can further include a multi-layer board (MLB) that can be electrically coupled to the power source, the speaker, and the waveguide. The device including a power source can be un-tethered from a power source and can be wireless, which can increase the comfort and range of motion for the user during operation.

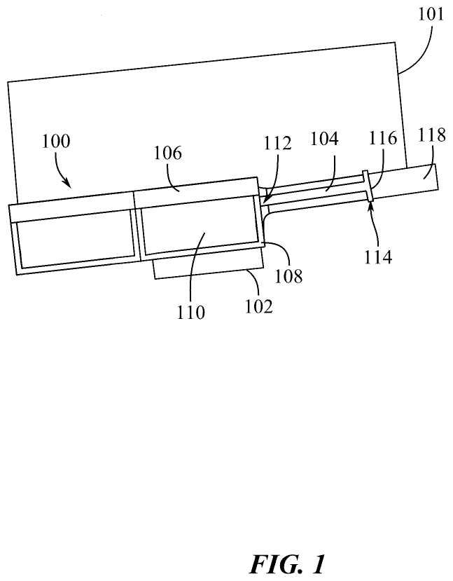

These and other embodiments are discussed below with reference to FIGS. 1-7B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates display accessory for a wearable device 100 donned on a user 101. The device 100 can be a head-mountable electronic device or can be any device or system configured to be worn on the head of the user 101, such as a head-mounted electronic device, an optical device, smart glasses, alternate/virtual reality goggles, and the like. The device 100 can include at least one housing 106, which can house a variety of electrical components and systems. In one example, the device 100 can further include a display frame 108, which can be coupled to the housing 106. In at least one example, the display frame 108 can be configured to secure one or more transparent windows 110 configured to present visual information to the user 101. In some examples, the window 110 can be coupled to the housing 106 without a display frame 108.

In one or more examples of the present disclosure, the transparent windows 110 can also include display screens, optically transparent display screens, transparent materials, optical lenses, or combination thereof, disposed in front of the eyes of the user 101. As shown in FIG. 1, the display frame 108 and the transparent windows 110 can be superimposed in relation to the user's eyeglasses 102. In one example, the eyeglasses 102 can include non-corrective eyeglasses, such as sunglasses, safety glasses, sports glasses, and so forth. In other examples, the eyeglasses 102 can include corrective lens eyeglasses. The display frame 108 and transparent windows 110 being overlaid over the user's eyeglasses 102 to act as a protective layer for the user's eyes. The user can then use their corrective eyeglasses 102 as intended while operating the display device 100. In one example, the housing 106 and display frame 108 can be made from a polycarbonate, carbon fiber, a composite material, or other durable, light-weight materials or combinations thereof.

As shown in FIG. 1, the device 100 can be configured to be coupled to the user's eyeglasses 102. The device 100 can include at least one connector 104. In at least one example, the connector 104 can removably couple the device 100 to the user's eyeglasses 102. The connector 104 can include a proximal end 112 and a distal end 114. The proximal end 112 of the connector 104 can be secured to the housing 106. In one example, the proximal end 112 of the connector 104 can include a hinge. In this way, the hinge can enable the connector 104 to rotate with a rotation of the securement arms 118 of the eyeglasses 102 when folded inward. As shown in FIG. 1, the connector 104 can extend from the housing 106. In one example, the connector 104 can be made from a polycarbonate, carbon fiber, a composite, or the like. In at least one example, the distal end 114 of the connector 104 can include a clip. In this example, the user can use the clip to secure the device 100 to a user's eyeglasses, for example to the securement arms 118 of the eyeglasses 102. In this way, when the user desires to operate the device, the user can easily connect the device 100 to the eyeglasses 102, then the user can easily remove the device 100 from the eyeglasses 102. In another example, the distal end 114 of the connector 104 can include a strap 116. As shown in FIG. 1, the strap 116 can wrap around the eyeglass securement arm 118, which secures the device 100 to the eyeglasses 102. The user can use the strap 116 to easily connect the device 100 to the eyeglasses 102, and to easily remove the device 100. The strap 116 can further be adjusted to accommodate any size of eyeglass securement arm 118 and not cause any damage during operations to the eyeglasses 102.

Any of the features, components, and/or parts, of the rim 360 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

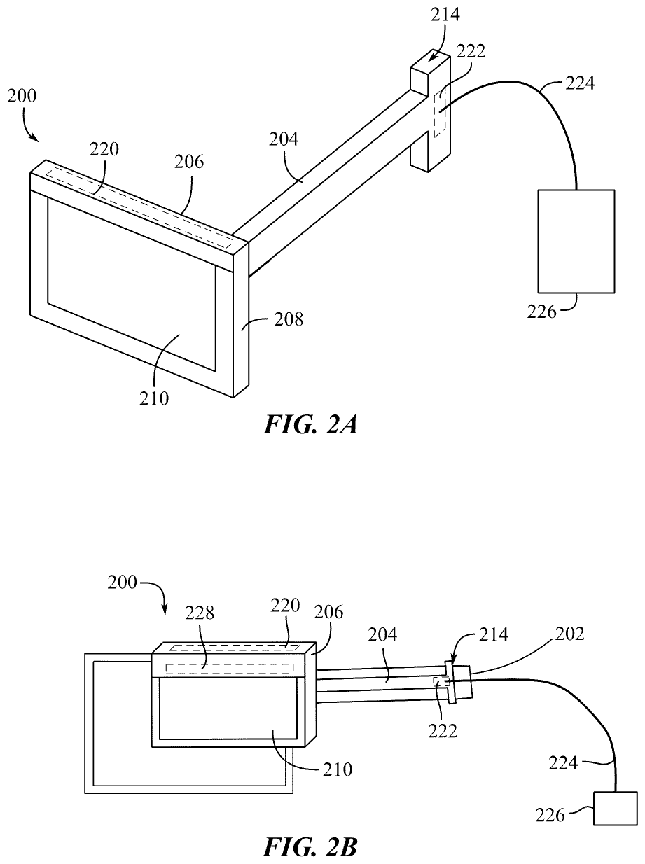

FIG. 2A illustrates one example of a display device 200 and FIG. 2B illustrates one example of a display device 200 connected to a pair of eyeglasses 202. The display device 200 can include at least one waveguide 220. The waveguide 220 can be configured to direct visible light at the transparent window 210 to create an image. The waveguide 220 can include a physical structure configured to guide electromagnetic waves, such as visible light. Examples of the waveguide 220 can include optical fiber waveguides, transparent dielectric waveguides, liquid light guides, and liquid waveguides. Examples of the waveguide 220 can also include a projector that acts as an input for the visible light displayed at the transparent window 210. In one example, the waveguide 220 can further include a fold within the transparent window 210, which can refract the visible light being projected. The waveguide 220 can direct the visible light at the transparent window 210 in such a way as to create on image for the user to observe through the display device 200. The image created can include a graphical image, letters, shapes, and the like. The waveguide 220 can be disposed within the housing 206 of the device 200. As shown in FIGS. 2A and 2B, the waveguide 220 can be disposed in the top of the housing 206 and direct light downward toward the transparent window 210. In one example, the waveguide 220 can be disposed in the sides of the display frame 208 or window 210, where the waveguide 220 can direct light from the right or left of the transparent window 210.

The device 200 can further include at least one electrical port 222. In one example, as shown in FIGS. 2A and 2B, the electrical port 222 can be disposed at the distal end 214 of the connector 204. The electric port 222 can be electrically coupled to the waveguide 220. In one example, as shown in FIGS. 2A and 2B, an electrical cable, cord, or wire 224 can be electrically coupled to the electric port 222. The wire 224 can be further electrically coupled to a power source 226. In one example, the power source 226 can include a battery pack. In this way, the user can travel with a battery pack to power the device 200 without being hindered by a large and/or stationary power source such as a wall outlet. As shown in FIG. 2B, the wire 224 can be tucked behind the user's ear along with the curvature of the eyeglasses 202 configured to rest behind the user's ear. Such a configuration can ensure the wire 224 does not interfere with the user's face or eyes during operation. In one example, the user can don the device 200 and tuck the wire 224 behind the user's ear and direct the wire 224 to the power source 226 down the user's back and store the power source 226 in the user's pocket.

In at least one example, the electric port 222 can include a data port configured to relay data between external data sources and one or more electronic components of the device 200. For example, the wire 224 can be a data transfer wire and the power source 226 can be a data source, which can include one or more data components, including processors, antennas, memory components, or other circuitry and components configured to receive and/or send data through the wire 224 to the device 200 through the electric port 222.

As shown in FIG. 2B, the device 200 can be attached to the user's eyeglasses 202 such that the transparent window 210 can align with the user's eyes. In one example, the device 200 can include a second connector 228 coupled to the housing 206. In this example, the second connector 228 can removably couple the housing 206 to the user's eyeglasses 202. The second connector 228 can further secure the device 200 to the eyeglasses 202 to ensure that during operation the device 200 is not moving in relation to the eyeglasses 202 or causing damage to the eyeglasses 202. A second connector 228 can remove any excessive movement of the device 200 during operations that diminishes the experience to the user by providing at least two secure points of contact. In one example, the second connector 228 can include a magnet, a perimeter suction, a spring clamp, an adhesive, a mechanical connector, or the like. In one example, the second connector 228 can engage with existing features on the eyeglasses 202. In one such example, the second connector 228 can include a mechanical connector that secures to an overhang defined by the eyeglasses 202. In this example, the overhang defined by the eyeglasses 202 can facilitate to a more secure engagement with the second connector 228. Alternatively, in some examples, securement features can be added, adhered to, or otherwise connected to the eyeglasses to facilitate a secure engagement of the device 200 to the eyeglasses 202.

Any of the features, components, and/or parts, of the rim 360 including the arrangements and configurations thereof shown in FIGS. 2A and 2B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A and 2B.

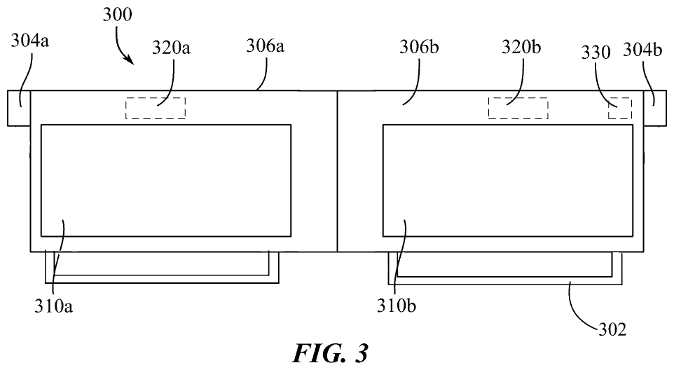

FIG. 3 illustrates a front view of one example of a display device 300 connected to a pair of eyeglasses 302. In one example, a housing 306a can be a first housing 306a, a transparent window 310a can be a first transparent window 310a, a connector 304a can be a first connector 304a, and a waveguide 320a can be a first waveguide 320a. In this example, the device 300 can include a second housing 306b and a second transparent window 310b secured to the second housing 306b. The device 300 can further include a second waveguide 320b disposed in the second housing 306b and a second connector 304b connected to the second housing 306b and configured to removably couple the second housing 306b to the eyeglasses 302. In such an example, the first waveguide 320a and the second waveguide 320b can be in electrical communication. In one example, the device 300 includes at least one antenna 330. In this example, the first waveguide 320a and the second waveguide 320b can be in communication via the antenna 330. The antenna 330 can enable the device 300 to connect to the internet, have cellular functionality, and connect to other devices via Bluetooth. In other examples, the first waveguide 320a and the second waveguide 320b can be in electrical communication via a hardwired connection between the first and second housings 306a, 306b.

As shown in FIG. 3, the device 300 can include a first housing 306a and a second housing 306b, wherein the user can secure the first housing 306a and the second housing 306b to the user's eyeglasses 302. In this way, both eyes of the user can be aligned with the first transparent window 310a and the second transparent window 310b, respectively. The user can have an AR experience with both eyes covered with device 300 to deliver a more stereoscopic experience. In one example, the user may only want to have one housing 306a connected to the user's eyeglasses 302. In this example, the device 300 can be used for informational use, delivering important information to one eye of the user, as the other eye of the user is unobstructed. In this example, electric ports of the first connector 304a and the second connector 304a (not shown in FIG. 3 but referenced as 222 in FIGS. 2A and 2B) can have individual wires (also shown in FIGS. 2A and 2B as 224) electrically coupled to the electrical ports. The electrical wires 224 can electrically couple to the power source 226, as shown in FIGS. 2A and 2B and described above. In this way, again referencing the device 300 in FIG. 3, the user can decide if the first housing 306a is powered, the second housing 306b is powered, or both are powered.

Any of the features, components, and/or parts, of the rim 360 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

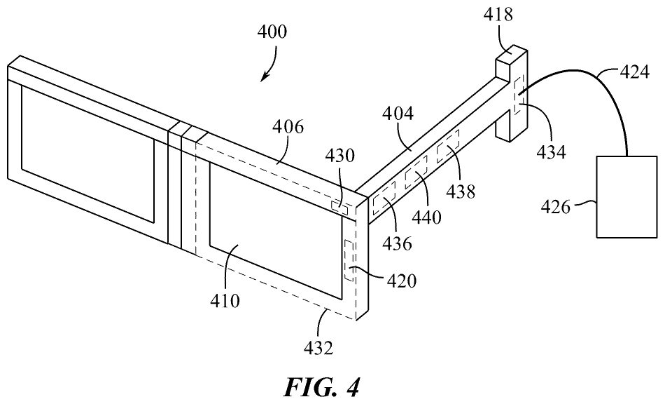

FIG. 4 illustrates an isometric view of one example of a wearable display device 400. In this example, the device 400 can include a display assembly 432. The display assembly can include a transparent window 410 that can be secured to a housing 406, and a waveguide 420. In one example, the device 400 can further include a port 434, including a power port and/or a data port, disposed in the connector 404. The port 434 can be electrically coupled to the waveguide 420. As shown in FIG. 4, the port 434 can be disposed in, at, or near the distal end 418 of the connector 404. In one example a power source 426 is electrically coupled to the power port via an electrical wire 424. The device 300 can include an antenna 430. The antenna 430 can be electrically coupled to the port 434.

In one example, the connector 404 can be a securement arm 404 that extends from the housing 406. In this example, the securement arm 404 can define an internal volume configured to house electrical components. The device 400 can include a controller 436 housed in the securement arm 404, for example within the internal volume, and electrically coupled to the port 434. The controller 436 can include at least one processor, at least one memory component, and one or more other components. The processor, the memory component, the antenna 430, and the other components can be operably connected with or to the controller 436. The processor, the memory component, the antenna 430, and the other components can be described as being operably connected such that the controller 436 is configured to receive data, control, and/or utilize the memory component, antenna 430, processors, and so forth. Additionally, the processor, the memory component, the antenna 430, and the other components can all be operably connected with or to each other, for example via an electrical coupling, and with or to other components of the electronic device 400. The antenna 430 can receive signals and can transmit the signals to the other components of the controller 436, for example the processor. Other electronic components in the securement arm 404 can include wires, logic boards, electronic connections, and flexes, or any other electronic or non-electronic component utilized by the controller 436 for operation. The controller 436 can be disposed within the securement arm 404. One or more processors of the controller 436 can be electrically coupled to one or more memory components of the controller 436, which store electronic instructions that, when executed by the processor, cause the controller to carry out the various functions, outputs, and methods described throughout the present disclosure.

In another example, the device 400 can include a speaker 438 housed within the securement arm 404, for example within an internal volume thereof, and can be electrically coupled to the port 434. As shown in FIG. 4, the speaker 438 can be housed within the securement arm 404 so that when donned on the user's head it aligns closest to the user's ear. The placement of the speaker 438 in the securement arm 404 can provide the best audio for the user. In yet another example, the device 400 can include a multi-layer board (MLB) 440 that can be housed within the securement arm 404 and can be electrically coupled to the port 434. In this example the MLB 440 can be electrically coupled to the controller 436, the speaker 438, and the antenna 430.

In at least one example, the port 434 can include a data port configured to relay data between external data sources and one or more electronic components of the device 400. For example, the wire 424 can be a data transfer wire and the power source 426 can be a data source, which can include one or more data components, including processors, antennas, memory components, or other circuitry and components configured to receive and/or send data through the wire 424 to the device 400 through the data port 434. In at least one example, the data source 426 can transfer data to one or more of the electronic components of the device 400, including but not limited to the controller 436, MLB 440, speaker 438, waveguide 420, and antenna 430. In such an antenna, components for data transfer noted above can be housed in or with the power and/or data source 426 such that those same components are not in the device 400, thus reducing the weight of the device for improved user comfort while maintaining the many functionalities of those components.

In at least one example, the power/data source 426 and the wire 424 can be part of a lanyard or other strop configured to wrap around the user's head between various securement arms. Lanyards or other straps can secure the device to a user's head and neck during use and in an unintended drop event.

Any of the features, components, and/or parts, of the rim 360 including the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

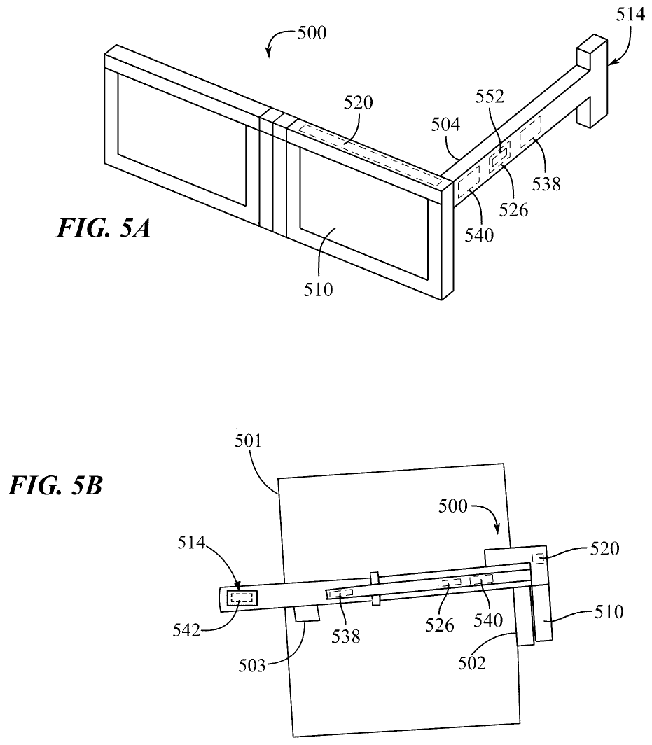

FIG. 5A illustrates an isometric view of one example of a wireless wearable display device 500. FIG. 5B illustrates a left side view of one example of a wireless wearable display device 500 donned on a user's head 501. In one example, the wireless wearable display device 500 includes a transparent window 510 and a waveguide 520 coupled to the transparent window 510. The device 500 further includes a securement arm 504 that can define an internal volume to house electrical components. In one example, the device 500 further includes a power source 526 that can be housed in the securement arm 404. In this example, the power source 526 can include a battery. In yet another example, the power source 526 can include an external port 552. In one example, the external port 552 can include a charging port such as a USB-A port, a USB-B port, or the like.

The device 500 can further include a speaker 538, which can be housed within securement arm 504. As shown in FIG. 5B, the speaker 538 can be housed within the securement arm 504 toward the distal end 514 of the securement arm 504. The speaker 538 positioned at or near the distal end 514, and thus closer to the user's ear, can provide high quality audio experiences. In other examples, the speaker 538 can be housed in different positions throughout the securement arm 504. The speaker 538 can be electrically coupled to the power source 526. In yet another example, the device 500 can include a multi-layer board (MLB) 540. In this example, the MLB 540 can be electrically coupled to the power source 526, the speaker 538, and the waveguide 520.

In one example, the securement arm 504 can cantilever from the transparent window 510. As shown in FIG. 5B, the securement arm 504 can define a curvature that secures the securement arm 504 behind the user's ear when the user dons the device 500. In this example, the device 500 can include a speaker driver 542 that can be housed within the securement arm 504 at the distal end 514 of the securement arm 504. As shown in FIG. 5B, the speaker driver 542 can be configured to be positioned distally behind the user's ear 503 when donned. In this way, the weight of the speaker driver 542 can be at the distal end 514 of the securement arm 504. The weight at the distal end 514 can create a counterweight about the ear 503 to shift the weight of the transparent window 510 and waveguide 520 at least partially off of the user's nose for comfort.

Any of the features, components, and/or parts, of the rim 360 including the arrangements and configurations thereof shown in FIGS. 5A and 5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A and 5B.

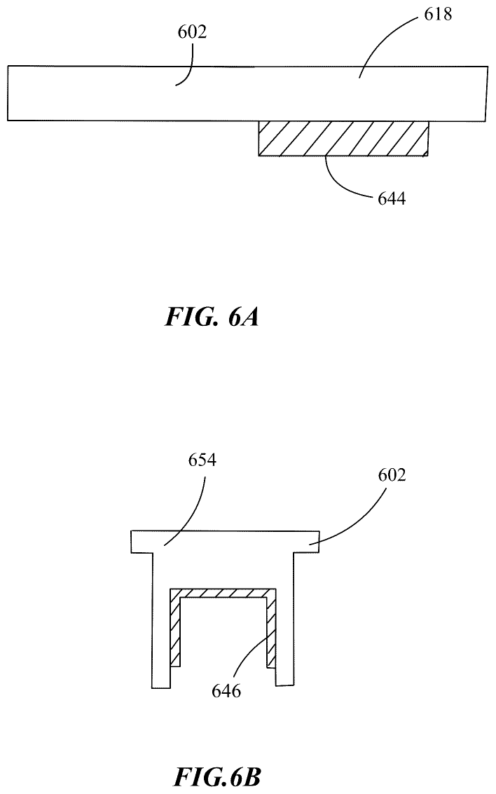

FIG. 6A illustrates an ear pad 644 attached to a pair of eyeglasses 602. As shown in FIG. 6A, the ear pad 644 can secure to the securement arm 618 of the eyeglasses 602, where the user's eyeglasses 602 rest and secure behind the user's ears. In one example, the user can secure the ear pad 644 to the eyeglasses 602 for prolonged use of the device 500 shown in FIGS. 5A and 5B and other devices illustrated and described above. The ear pad 644 can spread out point loads and reduce weight fatigue on the user's ear during operation of the device 500. In one example, the ear pad 644 can be made of foam, silicone, TPU, a bladder filled with air or fluid, for example non-Newtonian fluids, or the like.

FIG. 6B illustrates a nose pad 646 attached to a pair of eyeglasses 602. As shown in FIG. 6B, the nose pad 646 can secure to the bridge 654 of the eyeglasses, where the user's eyeglasses 602 rest on the bridge of the user's nose. In one example, the user can secure the nose pad 646 to the bridge 654 of the eyeglasses 602 for prolonged use of the device 500. The nose pad 646 can provide extra cushioning for the user's nose to increase comfort of the device 500 for prolonged operation. In one example, the nose pad 646 can be made of foam, silicone, TPU, an air-filled and/or fluid-filled bladder, or the like.

Any of the features, components, and/or parts, of the rim 360 including the arrangements and configurations thereof shown in FIGS. 6A and 6B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A and 6B.

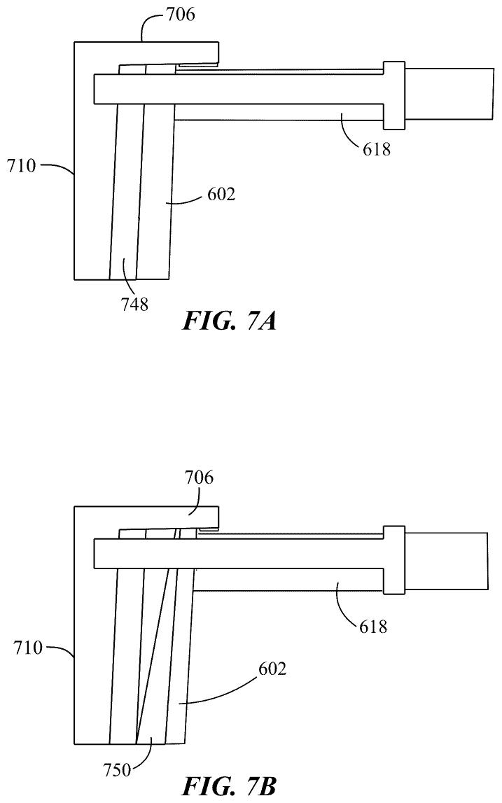

FIG. 7A illustrates one example of a transparent window 710 of a device 706 secured to eyeglasses 602, including a securement arm 618. In the illustrated example of FIG. 7A, the device 706 can engage an upper frame or portion of the device 602. In such an example, the device 706 can be removably secured to and engaged with either the securement arm 618, the upper frame portion of the device 706, or both. In one example, the transparent window 710 can include a hollow birdbath lens 748. In this example, the hollow birdbath lens 748 includes two main optical components, including a spherical mirror and a beam splitter. In this way, the spherical mirror can bounce the projection from the device 706 into the user's eye. The hollow birdbath lens 748 can reduce weight and thus operational fatigue for the user. FIG. 7B illustrates shows another example of a transparent window 710. In one example, the transparent window 710 can include a folded birdbath lens 750. In this example, the folded birdbath lens 750 can included multiple mirrors. The folded birdbath lens 750 can provide high quality images projected to the user's eye.

Any of the features, components, and/or parts, of the rim 360 including the arrangements and configurations thereof shown in FIGS. 7A and 7B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7A and 7B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A display accessory for eyeglasses, comprising:
a housing;
a transparent window secured to the housing;
a waveguide disposed in the housing and configured to direct visible light at the transparent window to create an image; and
a connector configured to removably couple the housing to the eyeglasses such that the housing engages an upper frame of the eyeglasses.

2. The display accessory of claim 1, wherein the connector further comprises:
a proximal end secured to the housing; and
a distal end extending from the housing.

3. The display accessory of claim 2, wherein the distal end of the connector comprises a clip to removably couple the housing to the eyeglasses.

4. The display accessory of claim 2, wherein the distal end of the connector comprises a strap to removably couple the housing to the eyeglasses.

5. The display accessory of claim 2, wherein the connector further comprises an electric port electrically coupled to the waveguide.

6. The display accessory of claim 1, wherein:
the housing is a first housing, the transparent window is a first transparent window, the waveguide is a first waveguide, and the connector is a first connector; and
the display accessory further comprises:
a second housing;
a second transparent window secured to the second housing;
a second waveguide disposed in the second housing; and
a second connector connected to the second housing;
wherein the first waveguide and the second waveguide are communicatively connected.

7. The display accessory of claim 6, further comprising an antenna, wherein the first waveguide and the second waveguide are communicatively connected via the antenna.

8. The display accessory of claim 1, wherein:
the connector is a first connector extending from the housing; and
the housing includes a second connector configured to removably couple the housing to the eyeglasses.

9. The display accessory of claim 1, further comprising:
a nose pad configured to removably couple to the eyeglasses; and
an ear pad configured to removably couple to the eyeglasses.

10. A wearable display device, comprising:
a housing;
a display assembly coupled to the housing and including:
a transparent window secured to the housing; and
a waveguide disposed in the housing and configured to direct visible light at the transparent window to create an image;
a connector configured to removably couple the housing to eyeglasses; and
a power port disposed in the connector and electrically coupled to the waveguide.

11. The wearable display device of claim 10, further comprising an antenna electrically connected to the power port.

12. The wearable display device of claim 11, further comprising a controller electrically connected to the power port.

13. The wearable display device of claim 10, further comprising a speaker electrically connected to the power port.

14. The wearable display device of claim 10, wherein the connector comprises a securement arm extending from the housing.

15. The wearable display device of claim 14, wherein the connector further comprises:
a proximal end secured to the housing; and
a distal end extending from the housing.

16. The wearable display device of claim 15, wherein the power port is disposed on the distal end of the connector.

17. A wireless wearable display device, comprising:
a transparent window;
a waveguide coupled to the window and configured to direct visible light at the transparent window to create an image; and
a securement arm cantilevered from the transparent window, the securement arm including a power source electrically coupled to the waveguide, the securement arm configured to removably couple the transparent window to eyeglasses.

18. The wireless device of claim 17, further comprising:
a speaker housed in the securement arm; and
a multi-layer board (MLB) electrically coupled to the power source, the speaker, and the waveguide.

19. The wireless device of claim 17, wherein the power source comprises a battery.

20. The wireless device of claim 17, wherein the power source comprises an external power port.
